(19) United States
(12) Patent Application Publication
(10) Pub. No.: US 2024/0402410 A1
(43) Pub. Date: Dec. 5, 2024

(54) ILLUMINATION DEVICE

(71) Applicant: Japan Display Inc., Tokyo (JP)

(72) Inventors: Shinichi KOMURA, Tokyo (JP); Toshiharu MATSUSHIMA, Tokyo (JP); Koichi OKUDA, Tokyo (JP)

(73) Assignee: Japan Display Inc., Tokyo (JP)

(21) Appl. No.: 18/731,537

(22) Filed: Jun. 3, 2024

(30) Foreign Application Priority Data
Jun. 5, 2023 (JP) 2023-092286

(51) Int. Cl. F21V 8/00; G06F 1/16

(52) U.S. Cl. CPC G02B 6/0028; G02B 6/002; G02B 6/0068; G06F 1/163

(57) ABSTRACT

According to one embodiment, an illumination device includes light sources, a distributing light guide element and a light guide. The distributing light guide element has a first side surface, a second side surface and light waveguides extending from the first side surface towards the second side surface. The light guide has a third side surface and a first main surface. Each of the light waveguides have a first end portion into which light emitted from a corresponding light source enters, and a second end portion from which the light propagating in the light waveguide is emitted. The light emitted from the second end portion enters the light guide via the second side surface and the third side surface and is emitted from the first main surface.

### CROSS-REFERENCE TO RELATED APPLICATIONS

This application is based upon and claims the benefit of priority from Japanese Patent Application No. 2023-092286, filed Jun. 5, 2023, the entire contents of which are incorporated herein by reference.

### FIELD

Embodiments described herein relate generally to an illumination device.

### BACKGROUND

In recent years, technology that provides, for example, virtual reality (VR) using a display device called a head-mounted display (HMD) mounted on the user's head portion has been attracting attention.

In the illumination device that constitutes such a head-mounted display, a number of laser diodes are installed. However, since laser diodes are expensive, head-mounted displays that require an illumination device a large number of laser diodes tend to be expensive.

### BRIEF DESCRIPTION OF THE DRAWINGS

FIG. 1 is a perspective view showing an example of an appearance of a display device according to an embodiment.

FIG. 2 is a perspective view schematically showing a configuration of a display panel installed in the display device according to the embodiment.

FIG. 3 is a cross-sectional view schematically showing a configuration of the display device according to the embodiment.

FIG. 4 is a plan view schematically showing an illumination device according to the first embodiment.

FIG. 5 is a cross-sectional view schematically showing the illumination device according to the first embodiment.

FIG. 6 is a plan view schematically showing an illumination device according to the second embodiment.

FIG. 7 is a cross-sectional view schematically showing the illumination device according to the second embodiment.

FIG. 8 is a plan view schematically showing an illumination device according to a modified example of the second embodiment.

FIG. 9 is a cross-sectional view schematically showing the illumination device according to the modified example of the second embodiment.

FIG. 10 is a plan view schematically showing an illumination device according to the third embodiment.

FIG. 11 is a cross-sectional view schematically showing the illumination device according to the third embodiment.

FIG. 12 is another cross-sectional view schematically showing the illumination device according to the third embodiment.

FIG. 13 is still another cross-sectional view schematically showing the illumination device according to the third embodiment.

FIG. 14 is a cross-sectional view schematically showing an illumination device according to a modified example of the third embodiment.

FIG. 15 is another cross-sectional view schematically showing the illumination device according to the modified example of the third embodiment.

FIG. 16 is a plan view schematically showing an illumination device according to the fourth embodiment.

FIG. 17 is a cross-sectional view schematically showing the illumination device according to the fourth embodiment.

### DETAILED DESCRIPTION

In general, according to one embodiment, an illumination device comprises light sources, a distributing light guide element and a light guide. The distributing light guide element includes a first side surface opposing the light sources, a second side surface on an opposite side to the first side, and waveguides extending from the first side surface towards the second side surface. The light guide includes a third side surface opposing the second side surface and a first main surface. Each of the light waveguides includes a first end portion into which light emitted from a corresponding light source enters, and a second end portion from which the light entering from the first end portion and propagating in the light waveguide is emitted. The light emitted from the second end portion enters the light guide via the second side surface and the third side surface, propagates in the light guide, and is emitted from the first main surface.

According to another embodiment, an illumination device comprises light sources, a distributing light guide element, a light guide, and a reflector. The distributing light guide element includes a first side surface opposing the light sources, a second side surface on an opposite side to the first side surface, and light waveguides extending from the first side surface towards the second side surface. The light guide is located above the distributing light guide element and includes a first main surface and a third side surface overlapping the second side surface in plan view. The reflector opposes the second side surface and the third side surface. Each of the light waveguides includes a first end portion into which light emitted from a corresponding light source enters, and a second end portion from which the light entering from the first end and propagating in the light waveguide is emitted. The light emitted from the second end portion is reflected by the reflector, enters the light guide, propagates in the light guide, and is emitted from the first main surface.

According to still another embodiment, an illumination device comprises light sources, a distributing light guide element and a reflector. The distributing light guide element includes a first side surface opposing the light sources, a second side surface on an opposite side to the first side surface, a first main surface, and light waveguides extending from the first side surface towards the second side surface. The reflector opposes the second side surface. Each of the light waveguides includes a first end portion into which light emitted from a corresponding light source enters, and a second end portion from which the light entering from the first end portion and propagating in the light waveguide is emitted. The light emitted from the second end portion is reflected by the reflector, propagates in the distributing light guide element, and is emitted from the first main surface.

Embodiments will now be described with reference to the accompanying drawings.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. Further, in the specification and drawings, corresponding elements are denoted by like reference numerals, and a detailed description thereof may be omitted unless otherwise necessary.

Further, in order to make the descriptions more easily understandable, some of the drawings illustrate an X axis, a Y axis and a Z axis orthogonal to each other. A direction along the X axis is referred to as a first direction, a direction along the Y axis is referred to as a second direction and direction along the Z axis is referred to as a third direction. A plane defined by the X axis and the Y axis is referred to as an X-Y plane, and a plane defined by the X axis and the Z axis is referred to as an X-Z plane. The third direction Z is a direction normal to the plane (X-Y plane) that includes the first direction X and the second direction Y. Further, viewing the various elements parallel to the third direction Z is referred to as plan view.

### First Embodiment

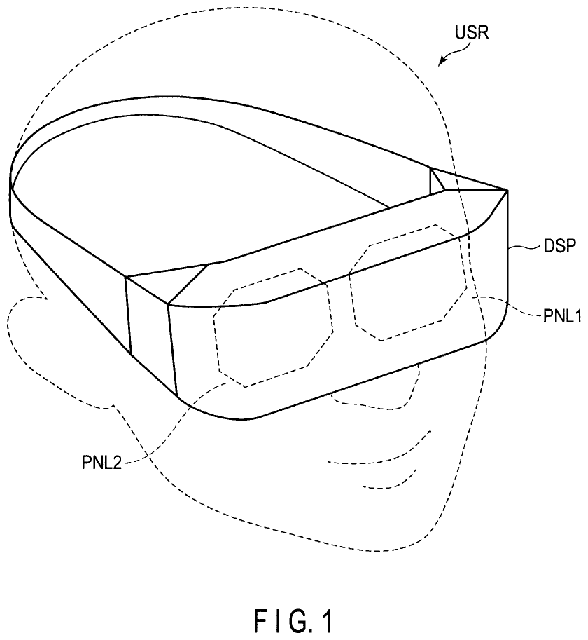

FIG. 1 is a perspective diagram showing an example of the appearance of a display device DSP according to an embodiment. The display device DSP of this embodiment is, for example, a head-mounted display (HMD) to be mounted on the head portion of a user USR and used by the user USR. The display device DSP is used to provide, for example, virtual reality (VR) to the user USR wearing the display device DSP.

The display device DSP comprises a display panel PNL1 for the left eye and a display panel PNL2 for the right eye. The display panel PNL1 is positioned in front of the left eye of the user USR when the user USR wears the display device DSP on his/her head. The display panel PNL2 is positioned in front of the right eye of the user USR when the user USR wears the display device DSP on his/her head. As will be described in detail later, the display panels PNL1 and PNL2 are, for example, liquid crystal display panels comprising liquid crystal layers.

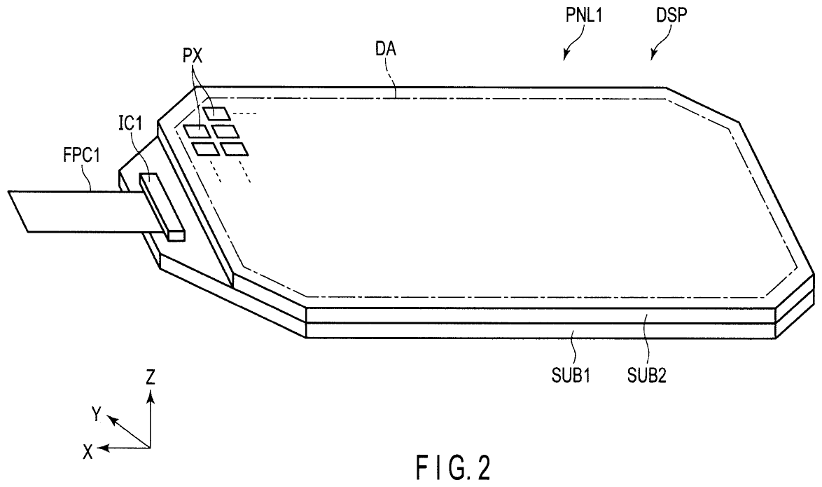

FIG. 2 is a perspective view schematically showing a configuration of the display panel PNL1 provided in the display device DSP of the embodiment. Note that the display panel PNL2 has a configuration similar to that of the display panel PNL1, though the illustration and description there are omitted here.

As shown in FIG. 2, the display panel PNL1 comprises a first substrate SUB1 and a second substrate SUB2 opposing the first substrate SUB1. The display panel PNL1 includes a display area DA which displays images. In the display area DA, a plurality of pixels PX are arranged in a matrix.

Further, the display panel PNL1 comprises a drive IC chip ICI that drives the display panel PNL1 and a flexible circuit board FPC1 that transmits control signals to the display panel PNL1. The flexible circuit board FPC1 is connected to a control module (not shown) that controls the operation of the display device DSP.

In an example shown in FIG. 2, the first substrate SUB1 and the second substrate SUB2 are each octagonal in shape in plan view. It can be said that the shapes of the first substrate SUB1 and the second substrate SUB2 are each a rectangle whose corners are notched. Since the shapes of the first substrate SUB1 and the second substrate SUB2 are octagons, the shape in plan view of the display panel PNL1 can as well be said as octagonal. However, the shape of the display panel PNL1 is not limited to this, but the shape of the display panel PNL1 should only be any shape that prevents the display panel PNL1 from hitting the nose of the user USR (that is, a shape with a notch portion, which is referred to as a nose cut). For example, the shape of the display panel PNL1 may be any polygon or circle with at least one corner adjacent to the nose of the user USR notched.

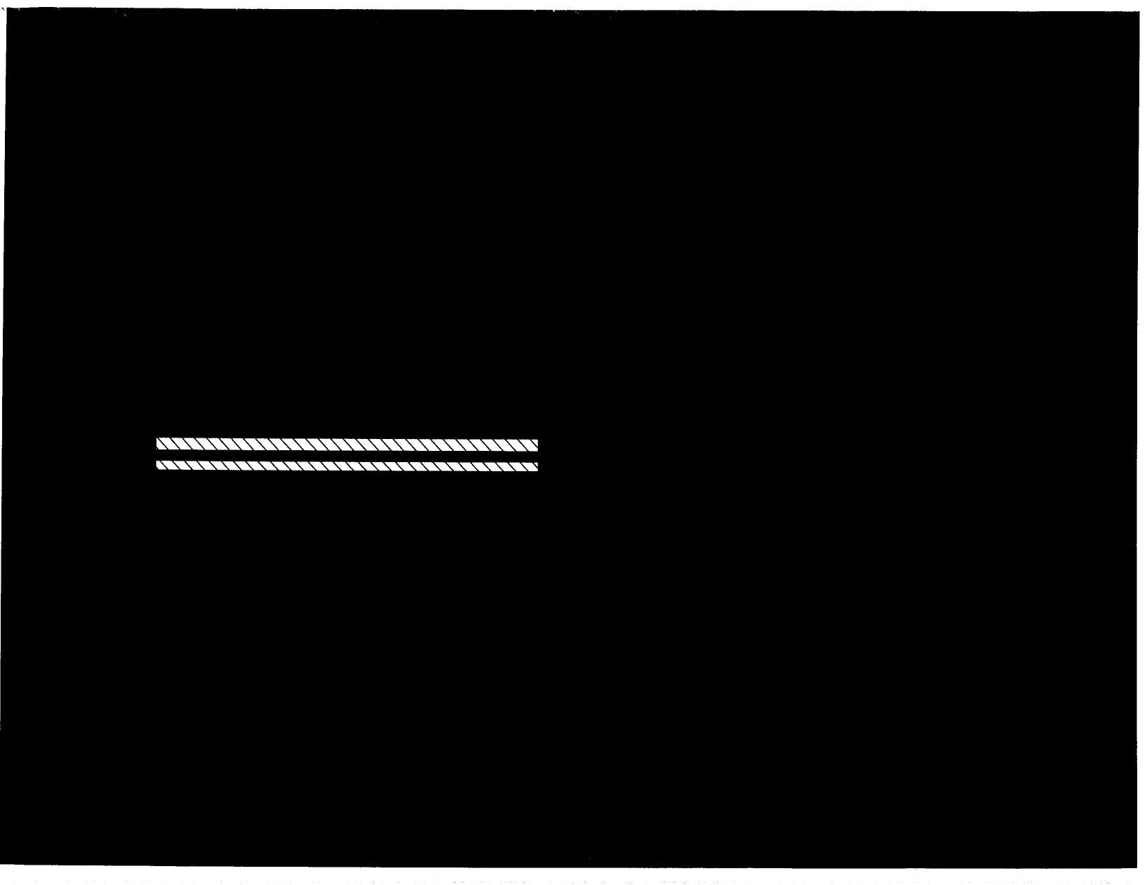

FIG. 3 is a cross-sectional view schematically showing a configuration of the display device DSP according to the embodiment. As shown in FIG. 3, the display device DSP comprises two display panels PNL1 and PNL2, a first polarizer PL1 and a second polarizer PL2, respectively, provided thereon, a prism sheet PS, a diffusion sheet DS, and an illumination device ILD. Note that the configuration related to the display panel PNL1 and the configuration related to the display panel PNL2 are similar to each other, and therefore only the configuration related to the display panel PNL1 will be described below, and the description of the configuration related to the display panel PNL2 will be omitted.

The display panel PNL1 further comprises a seal member SAL and a liquid crystal layer LC in addition to the first substrate SUB1 and second substrate SUB2 described above. In the display panel PNL1, the first substrate SUB1 and the second substrate SUB2 are adhered together by the seal member SAL. The liquid crystal layer LC is sealed between the seal member SAL and each of the substrates SUB1 and SUB2.

The first polarizer PL1 is disposed on a lower surface of the first substrate SUB1. The second polarizer PL2 is disposed on an upper surface of the second substrate SUB2. Polarization axes of the first polarizer PL1 and the second polarizer PL2 are, for example, orthogonal to each other.

The illumination device ILD is disposed on the rear surface side (that is, on an opposite side to the display surface) of each of the display panels PNL1 and PNL2. The illumination device ILD is connected to a control module that controls the operation of the display device DSP. The illumination device ILD illuminates the display panels PNL1 and PNL2. By illuminating the display panels PNL1 and PNL2 with the illumination device ILD, the display device DSP can display images on the display panels PNL1 and PNL2.

The prism sheet PS is disposed between the display panel PNL1 (display panel PNL2) and the illumination device ILD. Further, the diffusion sheet DS is disposed between the prism sheet PS and the display panel PNL1 (display panel PNL2). The prism sheet PS comprises a number of prisms that extend parallel to, for example, the second direction Y. These prisms are formed, for example, on the lower surface of the prism sheet PS. Note here that these prisms may as well be formed on an upper surface of the prism sheet PS.

The prism sheet PS converts light illuminated by the illumination device ILD into light substantially parallel to the third direction Z. Here, “light substantially parallel to the third direction z” includes not only light strictly parallel to the third direction Z, but also light whose inclination with respect to the third direction Z is converted to be sufficiently smaller by the prism sheet PS than when illuminated by the illumination device ILD. From the viewpoint of maintaining the polarization of the light illuminated by the illumination device ILD, the prisms of the prism sheet PS should preferably be formed on the lower surface. Light having passed through the prism sheet PS is diffused by the diffusion sheet DS to illuminate the display panels PNL1 and PNL2. Even in the case where the viewing angle of the light having passed through the prism sheet PS is narrow, the light is diffused by the diffusion sheet DS and thus the viewing angle can be widened.

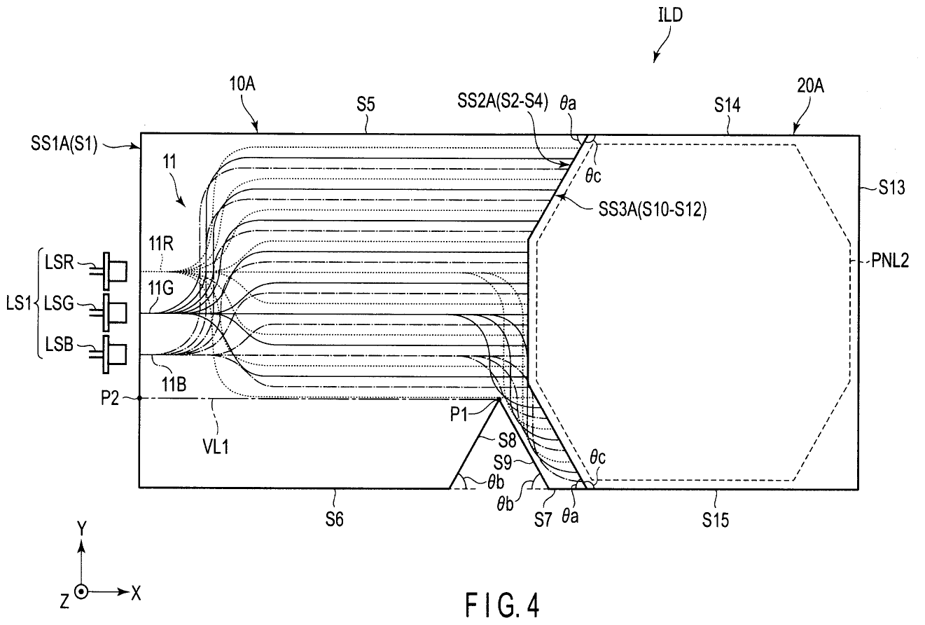

FIG. 4 is a plan view schematically showing the illumination device ILD of the first embodiment. Note that FIG. 4 illustrates only the elements that illuminate the display panel PNL2 among the elements that constitute the illumination device ILD.

As shown in FIG. 4, the illumination device ILD comprises a plurality of light sources LS1, a pair of a distributing light guide element 10A and a light guide 20A. The distributing light guide element 10A and the light guides 20A are connected adjacent to each other along the first direction X.

The plurality of light sources LS1 include a light source LSR which emits red laser light, a light source LSG which emits green laser light, and a light source LSB which emits blue laser light. When the plurality of light sources LS1 include a red light source LSR, a green light source LSG, and a blue light source LSB, it is possible to obtain light of a mixed color (for example, white) of the colors emitted by these light sources.

For the plurality of light sources LS1, for example, a laser diode such as a semiconductor laser that emits laser light can be used. The laser light may as well be a diffuse light having a spread centered in the direction of irradiation. Alternatively, the laser light may as well be polarized laser light.

The distributing light guide element 10A is formed, for example, of a glass material. The distributing light guide element 10A includes a side surface SS1A opposing the plurality of light sources LS1 and a side surface SS2A located on an opposite side to the side surface SS1A along the first direction X. The side surface SS2A corresponds to a connecting surface with the light guide 20A.

The distributing light guide element 10A includes a plurality of light waveguides 11 extending from the side surface SS1A to the side surface SS2A. The plurality of light waveguides 11 are formed in the distributing light guide element 10A, for example, by irradiating a laser beam onto glass and partially changing the refractive index of the glass. The plurality of light waveguides 11 include a light waveguide 11R corresponding to a red light source LSR (indicated by a dotted line in FIG. 4), a light waveguide 11G corresponding to a green light source LSG (indicated by a solid line in FIG. 4), and a light waveguide 11B corresponding to a blue light source LSB (indicated by a single-dotted line in FIG. 4). The light waveguides 11R, 11G, and 11B are each branched from one light waveguide into many light waveguides and are formed in layers over substantially the entire surface of the distributing light guide element 10A except for some areas, which will be described later.

The light guide 20A is formed, for example, of a resin material or a glass material. Note that the refractive index of the distributing light guide element 10A and the refractive index of the distributing light guide element 20A should preferably be about the same level. The light guide 20A includes a side surface SS3A connected to the side surface SS2A of the distributing light guide element 10A and opposes the display panel PNL2. The area of the light guide 20A in plan view should preferably be larger than the area of the display panel PNL2 in plan view.

Here, the planar shape of the distributing light guide element 10A will now be described. The distributing light guide element 10A includes a side S1 to a side S9.

The side S1 is a side corresponding to the side surface SS1A and extends along the second direction Y.

The sides S2 to S4 are sides corresponding to the side surface SS2A (connecting plane). The side S2 is an oblique side which extends along a direction which makes an angle θa with respect to the first direction X in the X-Y plane. The side S4 is an oblique side which extends along a direction which makes an angle θa with respect to the first direction X in the X-Y plane and which intersects the direction in which the above-described side S2 extends. The side S3 is a side which connects one end portion of the side S2 to one end portion of the side S4 and extends along the second direction Y. Note here the case where the angle made by the side S2 with the first direction X in the X-Y plane and the angle made by the side S4 with the first direction X in the X-Y plane are each the angle θa is illustrated as an example, but the angle made by the side S2 with the first direction X in the X-Y plane may be different from the angle made by the side S4 with the first direction X in the X-Y plane.

The side S5 is a side which connects one end portion of the side S1 and the other end portion of the side S2, and extends along the first direction X.

The side S6 is a side which extends from the other end portion of the side S1 along the first direction X. The side S7 is a side which extends from the other end portion of the side S4 along the first direction X so as to approach the side S6. The side S6 and the side S7 are spaced apart from each other.

The side S8 is an oblique side which extends from one end portion of the side S6 along a direction making an angle θb to the first direction X in the X-Y plane. The side S9 is an oblique side which extends from one end of side S7 along a direction that makes an angle θb with respect to the first direction X in the X-Y plane and intersects the direction in which the above-described side S8 extends. The side S8 and the side S9 intersect each other at an intersection point P1. According to this, a notch of an isosceles triangle shape (nose cut) can be formed in the distributing light guide element 10A.

Here, note that as shown in FIG. 4, the light waveguide 11 is not formed in an area surrounded by a virtual line VL1 extending from the intersection point P1 along the first direction X, a portion of the side S1 extending from the intersection point P2 of the virtual line VL1 and the side S1 toward the side S6, the side S6 and the side S8.

Next, the planar shape of the light guide 20A will be described. The light guide 20A includes a side S10 to a side S15.

The side S10 to the side S12 are sides corresponding to the side surface SS3A (connecting surface). The side S10 is an oblique side which extends along a direction which makes an angle θc (=180−θa) with respect to the first direction X in the X-Y plane. The side S12 is an oblique side which extends along a direction which makes an angle θc with respect to the first direction X in the X-Y plane and intersects the direction in which the above-described side S10 extends. The side S11 is a side which connects one end portion of the side S10 to one end portion of the side S12 and extends along the second direction Y. The side S10 to the side S12 overlap (come into contact with) the side S2 to the side S4 of the distributing light guide element 10A in plan view.

The side S13 is a side on an opposite side to the side S11 in the first direction X and extends along the second direction Y.

The side S14 is a side which connects the other end portion of the side S10 to one end portion of the side S13 and extends along the first direction X.

The side S15 is a side which connects the other end portion of the side S12 to the other end portion of the side S13 and extends along the first direction X.

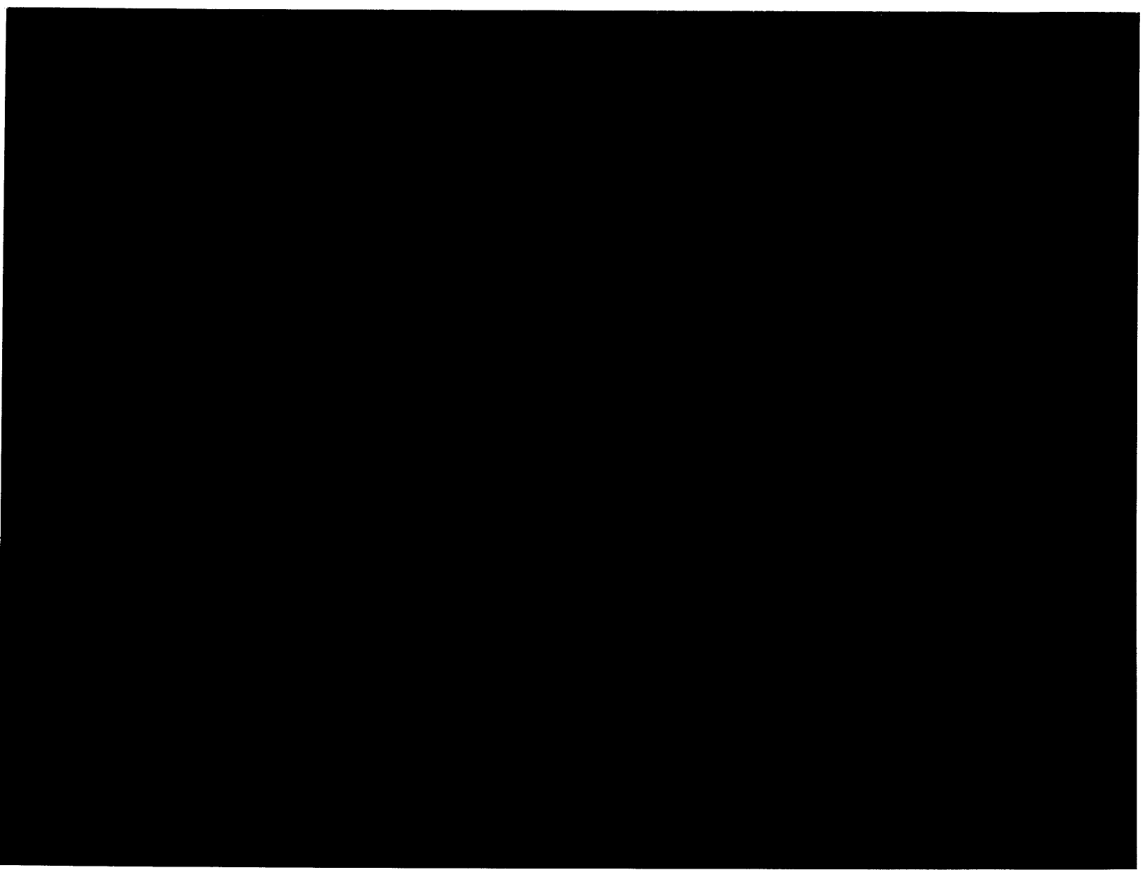

FIG. 5 is a cross-sectional view schematically showing the illumination device ILD according to the first embodiment.

As shown in FIG. 5, the illumination device ILD comprises a light source LS1, a pair of a distributing light guide element 10A and a light guide 20A for illuminating a display panel PNL2, and a light source LS2, a pair of a distributing light guide element 10B and a light guide 20B for illuminating a display panel PNL1. In the following descriptions, when it is not necessary to distinguish between the distributing light guide elements 10A and 10B from each other, they may as well be referred to simply as distributing light guide elements 10. Similarly, when it is not necessary to distinguish between the light guides 20A and 20B from each other, they may as well be referred to simply as light guides 20. Further, when it is not necessary to distinguish between the light sources LS1 and LS2 from each other, they may as well be referred to simply as light sources LS.

The distributing light guide element 10A includes a main surface MS1A opposing the display panel PNL1, a main surface MS2A located on an opposite side to the main surface MS1A along the third direction Z, a side surface SS1A opposing the light source LS1, and a side surface SS2A located on an opposite side to the side surface SS1A along the first direction X. The light guide 20A includes a main surface MS3A opposing the display panel PNL2, a main surface MS4A located on an opposite side to the main surface MS3A along the third direction Z, a side surface SS3A in contact with the side surface SS2A of the distributing light guide element 10A, and a side surface SS4A located on an opposite side to the side surface SS3A in the first direction X. On the main surface MS4A of the light guide 20A, a prism layer P1 including a plurality of prisms is provided.

Further, the distributing light guide element 10B includes a main surface MS1B opposing the main surface MS4A of the light guide 20A, a main surface MS2B located on an opposite side to the main surface MS1B along the third direction Z, a side surface SS1B opposing the light source LS2, and a side surface SS2B located on an opposite side to the side surface SS1B along the first direction X. The light guide 20B includes has a main surface MS3B opposing the main surface MS2A of the distributing light guide element 10A, a main surface MS4B located on an opposite side to the main surface MS3B along the third direction z, a side surface SS3B in contact with the side surface SS2B of the distributing light guide element 10B, and a side surface SS4B located on an opposite side to the side surface SS3B along the first direction X. On the main surface MS4B of the light guide 20B, a prism layer P2 including a plurality of prisms is provided.

Note that the distributing light guide elements 10A and 10B overlap each other at least partially in plan view, as shown in FIG. 5.

The distributing light guide element 10A includes a light waveguide 11R corresponding to a red light source LSR, a light waveguide 11G corresponding to a green light source LSG, and a light waveguide 11B corresponding to a blue light source LSB. The light waveguides 11R, 11G, and 11B are each formed hierarchically in different layers (heights) of the distributing light guide element 10A. FIG. 5 shows the case where the light waveguides 11R, 11G, and 11B are in this order from the top, but the light waveguides 11R, 11G, and 11B may as well be arranged from the top in an order different from that of FIG. 5. Further, FIG. 5 shows only one of each of the light waveguides 11R, 11G, 11B, but there may be multiple one of each of the light waveguides 11R, 11G and 11B formed in a hierarchical manner.

Each of the light waveguides 11R, 11G, and 11B includes an end portion 11a (in other words, an end portion 11A on a side surface SS1A side) into which light irradiated from the light source LS1 is input and an end portion 11b (in other words, an end portion 11b on a side surface SS2A side) out of which the light is output. For example, light irradiated from a red light source LSR enters the distributing light guide element 10A, and when the light enters the light waveguide 11R from the end portion 11a, it propagates in the light waveguide 11R, and is emitted from the end portion 11b toward the light guide 20A. Similarly, light irradiated from the green light source LSG enters the distributing light guide element 10A, and when the enters the light waveguide 11G from the end portion 11a, it propagates in the light waveguide 11G and is emitted from the end portion 11b toward the light guide 20A. Further, light irradiated from the blue light source LSB enters the distributing light guide element 10A, and when the light enters the light waveguide 11B from the end portion 11a, it propagates in the light waveguide 11B and is emitted from the end portion 11b toward the light guide 20A.

The light waveguides 11R, 11G, and 11B formed in the distributing light guide element 10A are bent in the third direction Z (downward) near the end portion 11b. More particularly, the light waveguides 11R, 11G, and 11B are bent downward at an angle θd (for example, 26.5°) with respect to the first direction X in the X-Z plane.

Note here that the above-provided descriptions are set out while taking the distributing light guide element 10A as an example, and the distributing light guide element 10B as well has a similar configuration.

Of the light emitted from the end portions 11b of the light waveguides 11R, 11G and 11B and entering the light guide 20A, the part thereof proceeding toward the main surface MS3A is reflected at an interface between the main surface MS3A of the light guide 20A and the air layer. Further, of the light entering the light guide 20A, the part thereof proceeding toward the main surface MS4A now has its proceeding direction changed by the prism layer P1 on the main surface MS4A. The light whose proceeding direction is changed by the prism layer P1 deviates from the total reflection condition of the main surface MS3A and is emitted from the main surface MS3A. The light emitted from the main surface MS3A is converted into light substantially parallel to the third direction Z by the prism sheet PS and then diffused by the diffusion sheet DS to illuminate the display panel PNL2.

Similarly, of the light emitted from the end portions 11b of the light waveguides 11R, 11G, and 11B and entering the light guide 20B, the part thereof proceeding toward the main surface MS3B is reflected at an interface between the main surface MS3B of the light guide 20B and the air layer. Further, of the light entering the light guide 20B, the part thereof proceeding toward the main surface MS4B has its proceeding direction changed by the prism layer P2 provided on the main surface MS4B. The light whose proceeding direction is changed by the prism layer P2 deviates from the total reflection condition of the main surface MS3B and is emitted from the main surface MS3B. The light emitted from the main surface MS3B is transmitted through the distributing light guide element 10A, converted into light substantially parallel to the third direction Z by the prism sheet PS, and then diffused by the diffusion sheet DS to illuminate the display panel PNL1.

The illumination device ILD of the first embodiment described above comprises distributing light guide elements 10A and 10B each including a plurality of light waveguides 11R corresponding to a red light source LSR, a plurality of light waveguides 11G corresponding to a green light source LSG, and a plurality of light waveguides 11B corresponding to a blue light source LSB. According to this, when at least one red light source LSR, one green light source LSG, and one blue light source LSB are provided for each of the distributing light guide elements 10A and 10B, light can be supplied to the entire side surfaces SS3A and SS3B of the light guides 20A and 20B via the light waveguides 11R, 11G, and 11B. In other words, the number of laser diodes to be provided in the illumination device ILD can be reduced, and the cost of the illumination device ILD, and accordingly the cost of the display device DSP, can be lowered.

The light emitted from the end portions 11b of the plurality of light waveguides 11R, 11G, and 11B is emitted toward the display panels PNL1 and PNL2. That is, the light emitted from the plurality of end portions 11b located along the second direction Y enters the light guides 20A and 20B generally from the side surfaces SS3A and SS3B opposing the respective end portions 11b and is emitted toward the display panels PNL1 and PNL2. Note here that the display panel PNL2 is octagonal, the upper and lower portions along the second direction Y in plan view have a light emission area smaller than that of the central portion along the second direction Y. With this configuration, when the end portions 11b of the plurality of light waveguides 11R, 11G and 11B are uniformly arranged along the second direction Y, the luminance along the second direction Y is not made uniform. In order to achieve uniform luminance in the second direction Y, the intensity of the light emitted from each of the end portions 11b in the upper and lower portions along the second direction Y need to be weaken to lower than the intensity of light emitted from each of the end portions 11b in the central portion in the second direction Y. Therefore, the end portions 11b of the plurality of light waveguides 11R, 11G and 11B are arranged at different pitches. More specifically, the pitches of the end portions 11b are set longer in the upper and lower portions in the second direction Y than in the central portion in the second direction Y. With this configuration, it is possible to emit light with uniform luminance toward the display panels PNL1 and PNL2.

Further, even in the case where the distributing light guide elements 10A and 10B have a notch (nose cut), when the plurality of light waveguides 11R, 11G, and 11B are formed in a curved shape, the end portions 11b of the plurality of light waveguides 11R, 11G, and 11B can be located over the entire side surfaces SS3A and SS3B of the light guides 20A and 20B. In other words, according to the illumination device ILD of the first embodiment, even if it has a notch (nose cut), the chromaticity and luminance of the light emitted from the main surfaces MS3A and MS3B of the light guides 20A and 20B can be made uniform. With this configuration, it is possible to suppress the occurrence of the color cracking discussed above.

Note here that it is considered to be sufficient to provide at least one red light source LSR, one green light source LSG, and one blue light source LSB for each of the distributing light guide elements 10A and 10B. But the number of light sources for each color, to be provide on each of the distributing light guide elements 10A and 10B may be increased, in which case, the curvature of the light waveguides 11R, 11G, and 11B can be made gradual. With this configuration, the light waveguides 11R, 11G, and 11B can be formed more easily as compared to the case where the light waveguides 11R, 11G, and 11B with steep curvatures are formed in the distributing light guide elements 10A and 10B.

Further, note that this embodiment is described on the assumption that the light distributing light guide element 10 and the light guide 20 are formed separately. But the configuration corresponding to the light distributing light guide element 10 and the configuration corresponding to the light guide 20 may be formed from a single piece of glass, and the configuration corresponding to the prism layer P may be provided (attached) below the configuration corresponding to the light guide 20. In this manner, the configuration corresponding to a pair of distributing light guide element 10 and a light guide 20 can be formed as well.

### Second Embodiment

Next, the second embodiment will be described. In the second embodiment, an illumination device ILD to be mounted on in a display device DSP that does not support nose cutting will be described. For this reason, although the details will be described later, the illumination device ILD of the second embodiment is different from that of the first embodiment in that the shape thereof in plan view is rectangular and does not have a notch (nose cut). In the following descriptions, explanations of parts similar to those of the first embodiment will be omitted.

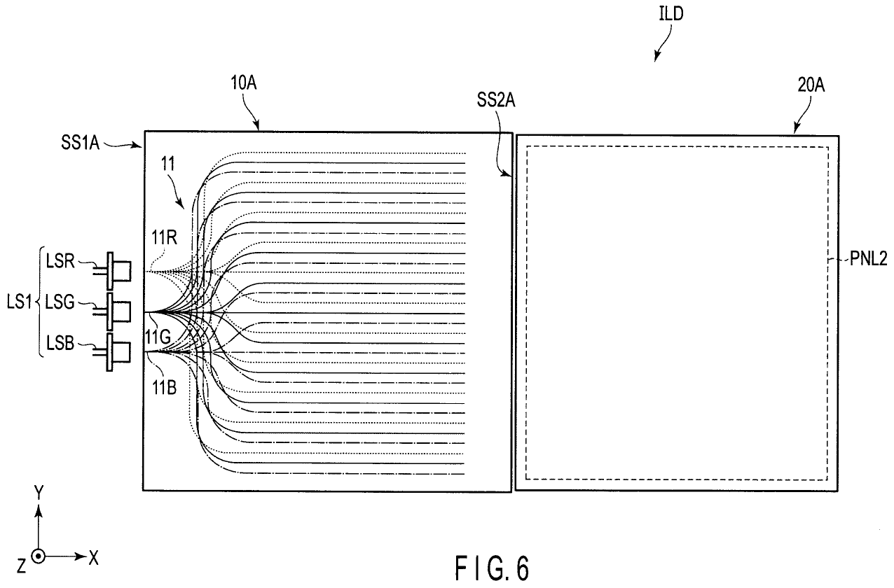

FIG. 6 is a plan view schematically showing the illumination device ILD of the second embodiment. Note that FIG. 6 illustrates only the elements that illuminate the display panel PNL2 among the elements that constitute the illumination device ILD.

As shown in FIG. 6, the shape of the distributing light guide element 10A in plan view is rectangular. As in the case of the configuration shown in FIG. 4, the distributing light guide element 10A includes a plurality of light waveguides 11 extending from the side surface SS1A which opposes a plurality of light sources LS1 towards the side surface SS2A. The plurality of light waveguides 11 are arranged over the entire surface of the distributing light guide element 10A, and in this respect, the configuration is different from that shown in FIG. 4.

As shown in FIG. 6, the shape of the light guide 20A in plan view as well is rectangular. The light guide 20A is disposed at a predetermined distance along the first direction X from the side surface SS2A of the distributing light guide element 10A, so as to oppose the rectangular display panel PNL2. As will be described in detail later, it suffices if the light guide 20A is disposed at a location where light emitted from the plurality of light waveguides 11 formed in the distributing light guide element 10A can enter. In other words, the light guide 20A may be disposed at a predetermined distance along the first direction X from the side surface SS2A of the distributing light guide element 10A as shown in FIG. 6, or it may be disposed to be brought into contact with the side surface SS2A of the distributing light guide element 10A in plan view.

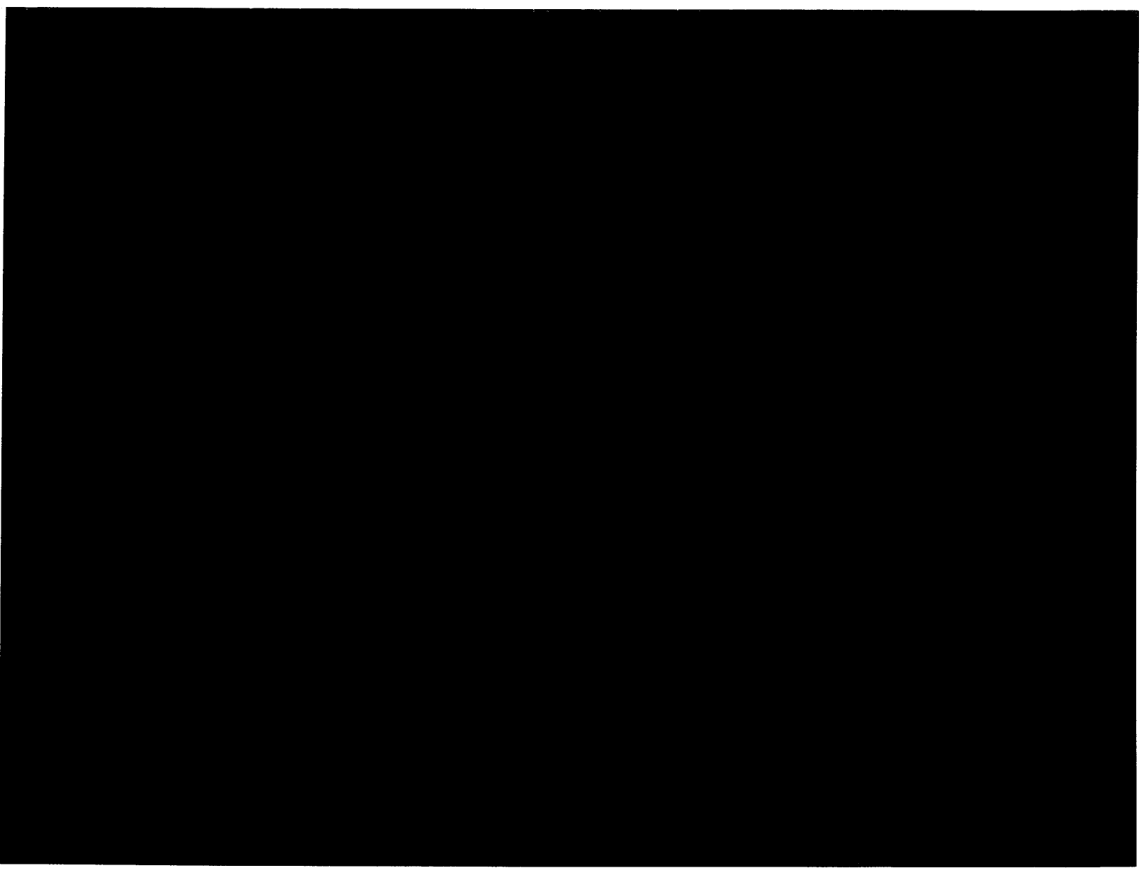

FIG. 7 is a cross-sectional view schematically showing the illumination device ILD of the second embodiment. Note that the pair of the distributing light guide element 10A and the light guide 20A and the pair of the distributing light guide element 10B and the light guide 20B have configurations similar to each other. Therefore, in the following, the description of only the distributing light guide element 10A and the light guide 20A will be provided, and the description of the distributing light guide element 10B and the light guide 20B will be omitted.

As shown in FIG. 7, in the illumination device ILD of the second embodiment, the distributing light guide element 10A and the light guide 20A are arranged along the first direction X at a predetermined interval. The thickness (length in the third direction Z) of the distributing light guide element 10A is less than the thickness of the light guide 20A. But note that the thickness of the distributing light guide element 10A may be the same as the thickness of the light guide 20A.

The light waveguides 11R, 11G, and 11B formed in the distributing light guide element 10A are different from those of the structure shown in FIG. 5 in that they extend parallel to the X-Y plane and do not bend downward near the end portions 11b. The light emitted from the end portions 11b of the light waveguides 11R, 11G, and 11B proceeds along the normal direction of the side surface SS2A and is emitted from the distributing light guide element 10A without being refracted (without being substantially refracted) by the side surface SS2A. Note that, in reality, the light emitted from the end portions 11b of the light waveguides 11R, 11G, and 11B is diffusing light, and therefore some of it is refracted at the side surface SS2A and emitted from the distributing light guide element 10A. It suffices if the light guide 20A is disposed close to the distributing light guide element 10A to such an extent that all such light emitted from the distributing light guide element 10A can enter the light guide 20A.

The side surface SS3A of the light guide 20A is inclined at an angle de with respect to the main surface MS3A. With this configuration, light emitted from the distributing light guide element 10A can be refracted at the side surface SS3A and made incident on the light guide 20A. The light entering the light guide 20A propagates in the light guide 20A, and is changed in the proceeding direction by the prism layer P1 provided on the main surface MS4A to deviate from the total reflection condition of the main surface MS3A, and is emitted from the main surface MS3A. Note that FIG. 7 shows, for convenience of illustration, the light, at the time before hitting the prism layer P1, is emitted from the main surface MS3A, but in reality, the light whose proceeding direction is changed by the prism layer P1 is emitted from the main surface MS3A as described above. The light emitted from the main surface MS3A is converted into light substantially parallel to the third direction Z by the prism sheet PS and then diffused by the diffusion sheet DS to illuminate the display panel PNL2. Note that the angle θe described above should preferably be set so that the light propagating in the light guide 20A makes an angle θd (for example, 26.5°) with respect to the first direction X in the X-Z plane.

The illumination device ILD of the second embodiment described above can exhibits advantageous effects similar to those of the first embodiment provided above, except that it does not support a nose cut.

Further, in the illumination device ILD according to the second embodiment, the light waveguides 11R, 11G and 11B formed in the distributing light guide elements 10A and 10B need not be bent downward near the end portions 11b, and therefore, as compared to the structure according to the first embodiment, the light waveguides 11R, 11G, and 11B can be formed in the distributing light guide elements 10A and 10B more easily. On the other hand, in the illumination device ILD according to the second embodiment, it is necessary to incline the side surfaces SS3A and SS3B of the light guides 20A and 20B at an angle θe with respect to the main surfaces MS3A and MS3B in order to make the light emitted from the distributing light guide elements 10A and 10B enter the light guides 20A and 20B. But the formation of the light guides 20A and 20B with inclined side surfaces SS3A and SS3B is easier than bending the light waveguides 11R, 11G, and 11B downward. Thus, the illumination device ILD of the second embodiment can be more easily fabricated than the illumination device ILD of the first embodiment.

### Modified Example of Second Embodiment

Now, a modified example of the second embodiment will be described. The illumination devices ILD according to the modified example of the second embodiment is different from that of the second embodiment in that the display panels PNL1 and PNL2 are individually illuminated. For convenience of explanation, an illumination device ILD that illuminates the display panel PNL1 may be referred to as an illumination device ILD1 and another illumination device ILD that illuminates the display panel PNL2 may be referred to as an illumination device ILD2. In the following descriptions, explanations of parts similar to those of the second embodiment will be omitted.

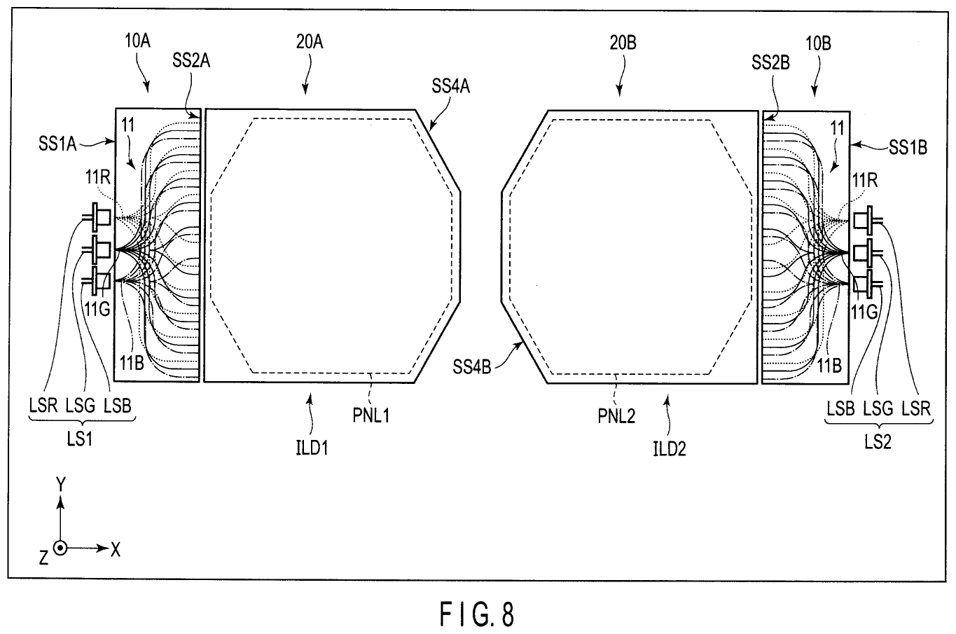

FIG. 8 is a plan view schematically showing the illumination devices ILD1 and ILD2 according to modified example of the second embodiment.

As shown in FIG. 8, the illumination device ILD1 comprises a light source LS1, a pair of a distributing light guide element 10A and a light guide 20A. Similarly, the illumination device ILD2 comprises a light source LS2, a pair of a distributing light guide element 10B and a light guide 20B. Note that the illumination devices ILD1 and ILD2 have configurations similar to each other, and therefore only the illumination device ILD1 will be described below, and the description of the illumination device ILD2 will be omitted.

As shown FIG. 8, the shape of the distributing light guide element 10A in plan view is rectangular. As in the case of the structure shown in FIG. 6, the distributing light guide element 10A includes a plurality of light waveguides 11 extending from the side surface SS1A opposing a plurality of light sources LS1 towards the side surface SS2A. The plurality of light waveguides 11 are disposed over the entire surface of the distributing light guide element 10A, and in this respect, the structure is similar to that shown in FIG. 6. However, the distributing light guide element 10A of the modified example is different in structure from that shown in FIG. 6 in that the length thereof along the first direction X is shorter than that of the distributing light guide element 10A of the second embodiment, and further the length of the light waveguides 11 is shorter, as well as that the curvature of the light waveguides 11 is steeper.

As shown in FIG. 8, the shape of the light guide 20A in plan view is hexagonal, which may be said as a shape in which two corners on the side surface SS4A side are cut off from the rectangular-shaped light guide 20A shown in FIG. 6. The light guide 20A is disposed at a predetermined distance in the first direction X from the side surface SS2A of the distributing light guide element 10A and opposes the octagonal-shaped display panel PNL1. As described above, since the display panel PNL1 and the light guide 20A have shapes with a notch (nose cut), the illumination device ILD1 of the modified example can be mounted on a display device DSP which supports the nose cut.

Note that the light guide 20A may as well be disposed at a predetermined distance in the first direction X from the side surface SS2A of the distributing light guide element 10A as shown in FIG. 8, or may be disposed so as to be brought into contact with the side surface SS2A of the distributing light guide element 10A in plan view.

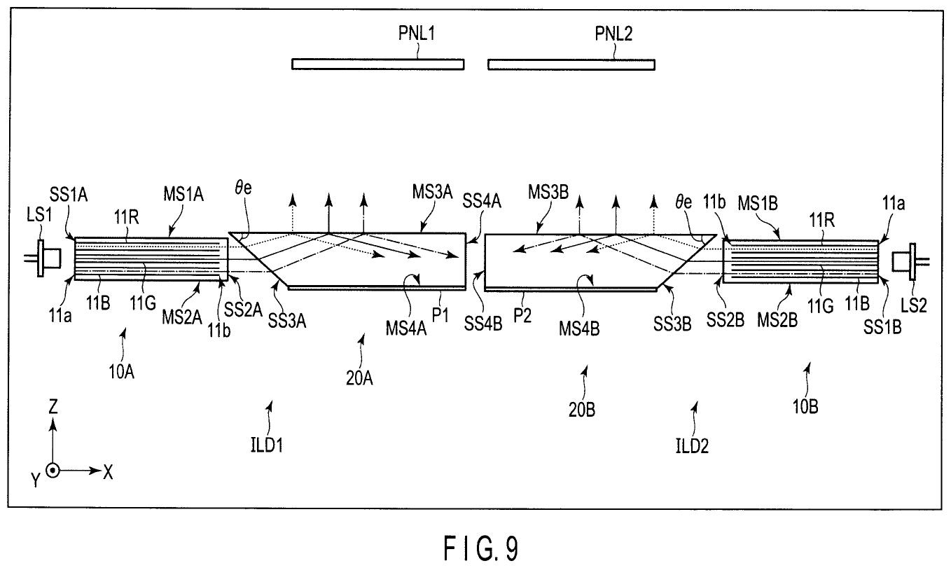

FIG. 9 is a cross-sectional view schematically showing the illumination devices ILD1 and ILD2 according to a modified example of the second embodiment. Note that a pair of the distributing light guide elements 10A and the light guide 20A and a pair of the distributing light guide elements 10B and the light guide 20B each have a cross-sectional structure similar to that shown in FIG. 7, and therefore, a detailed description thereof is omitted. This example is different from the second embodiment in that the light irradiated from the light source LS1, entering the light guide 20A via the distributing light guide element 10A and emitted from the main surface MS3A of the light guide 20A illuminates the display panel PNL1, and the light irradiated from the light source LS2, entering the light guide 20B via the distributing light guide element 10B and emitted from the main surface MS3B of the light guide 20B illuminates the display panel PNL2.

The illumination device ILD according to the modified example of the second embodiment described above can be mounted in the display device DSP supporting the nose cut, and can exhibit advantageous effects similar to those of the first embodiment described above. Further, the illumination device ILD according to the modified example of the second embodiment can be mounted not only in the display device DSP as a head-mounted display, but also in, for example, the display device DSP in which a display panel PNL is arranged only in front of one eye, the display device DSP as a smart phone, the display device DSP as a monitor, and the like.

### Third Embodiment

Next, the third embodiment will be described.

The illumination device ILD according to the third embodiment is different from those of the first embodiment and the second embodiment in that the display panels PNL1 and PNL2 are individually illuminated. In the following, for convenience of explanation, the illumination device ILD that illuminates the display panel PNL1 may be referred to as an illumination device ILD1 and the illumination device ILD that illuminates the display panel PNL2 may be referred to as an illumination device ILD2.

Further, the illumination device ILD of the third embodiment is different from those of the first embodiment, the second embodiment, and the modified example of the second embodiment in that a pair of the distributing light guide element 10 and the light guide 20 are arranged along the third direction Z, that is, in more detail, a pair of the distributing light guide elements 10 and the light guide 20 are arranged so as to overlap each other in plan view.

Note that in the following descriptions, explanations of the parts similar to those of the first embodiment, the second embodiment and the modified examples of the second embodiment will be omitted.

FIG. 10 is a plan view schematically showing the illumination devices ILD1 and ILD2 according to the third embodiment.

As shown in FIG. 10, the illumination device ILD1 comprises a light source LS1, a pair of a distributing light guide element 10A and a light guide 20A, and a reflector REF1. Similarly, the illumination device ILD2 comprises a light source LS2, a pair of a distributing light guide element 10B and a light guide 20B, and a reflector REF2. Note here that the illumination devices ILD1 and ILD2 have structures similar to each other, only the illumination device ILD1 will be described below, and the description of the illumination device ILD2 will be omitted.

As shown in FIG. 10, the shape of the distributing light guide element 10A in plan view is a pentagon, which can be said as a shape in which one corner on the side surface SS2A side is cut off from the rectangular distributing light guide element 10A shown in FIG. 6. The distributing light guide element 10A includes a side surface SS1A, a side surface SS2A located on an opposite side to the side surface SS1A along the first direction X, a side surface SS5A opposing the plurality of light sources LS1, and a side surface SS6A located on an opposite side to the side surface SS5A along the second direction Y. The distributing light guide element 10A includes a plurality of light waveguides 11R, 11G, and 11B extending from the side surface SS5A towards the side surface SS6A. The plurality of light waveguides 11R, 11G, and 11B are arranged in layers hierarchically over the entire surface of the distributing light guide element 10A.

As shown in FIG. 10, the light guide 20A is disposed to overlap the distributing light guide element 10A in plan view, and includes a side surface SS3A overlapping the side surface SS1A of the distributing light guide element 10A, a side surface SS4A overlapping the side surface SS2A of the distributing light guide element 10A, a side surface SS7A overlapping the side surface SS5A of the distributing light guide element 10A, and a side surface SS8A overlapping the side surface SS6A of the distributing light guide element 10A. The shape of the light guide 20A in plan view is a pentagon as in the case of the distributing light guide element 10A, and can be said as a shape in which one corner on the side surface SS4A side is cut off from the rectangular light guide 20A shown in FIG. 6. The light guide 20A opposes the octagonal-shaped display panel PNL1. As described above, since the display panel PNL1, the distributing light guide element 10A and the light guide 20A each have a shape with a notch (nose cut), the illumination device ILD1 according to the third embodiment can be mounted on a display device DSP supporting the nose cut.

Note that the distributing light guide element 10A and the light guide 20A are arranged so that a part of the distributing light guide element 10A and a part of the light guide 20A are brought into contact with each other. That is, light emitted from the distributing light guide element 10A enters the light guide 20A without being reflected at the interface.

As will be described in detail later, the reflector REF1 is disposed at a position opposing the side surface SS6A of the distributing light guide element 10A and the side surface SS8A of the light guide 20A, as shown in FIG. 10. The reflector REF1 may be disposed so as to be in contact with the side surface SS6A of the distributing light guide element 10A and the side surface SS8A of the light guide 20A in plan view, or it may be disposed at a predetermined distance along the second direction Y from the side surface SS6A and the side surface SS8A.

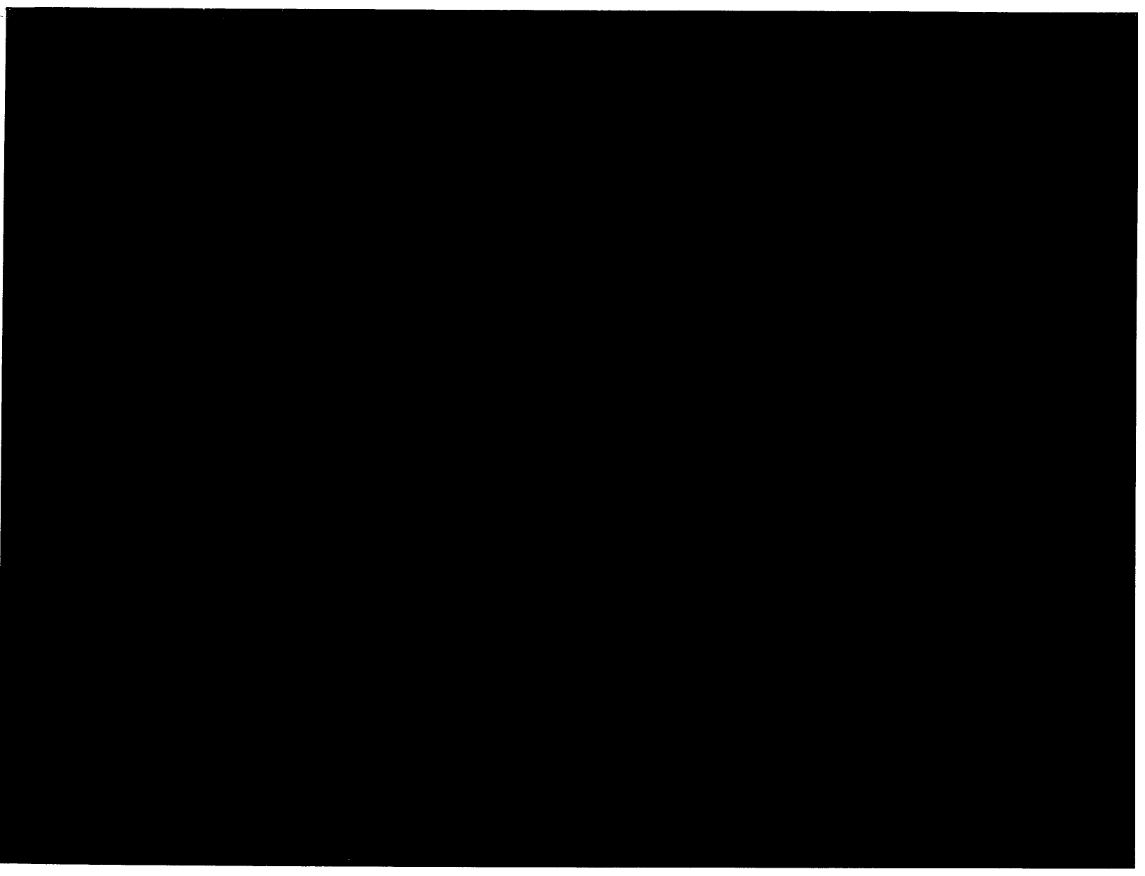

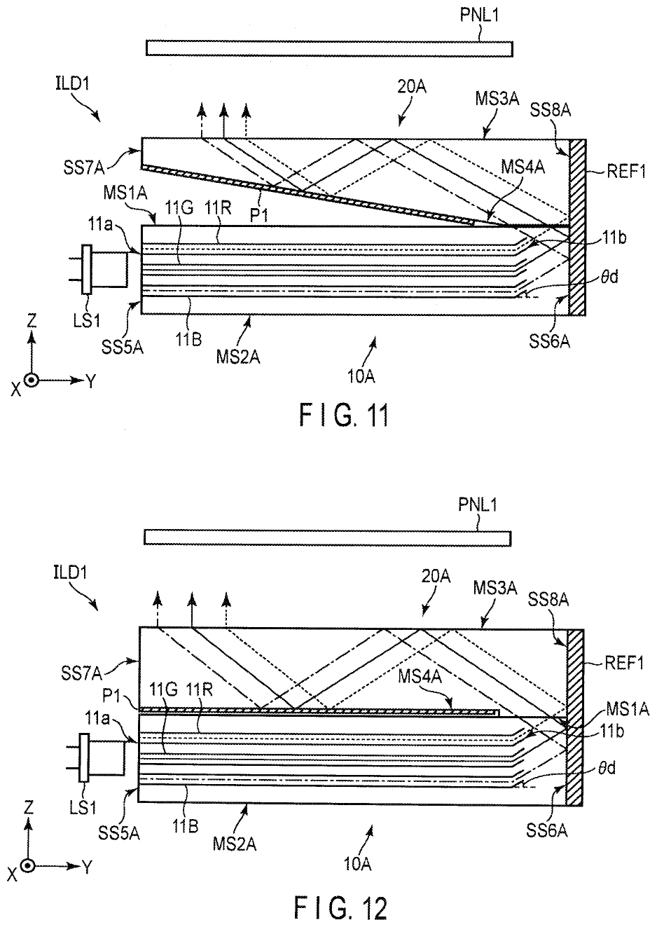

FIG. 11 is a cross-sectional view schematically showing the illumination device ILD1 according to the third embodiment. As shown in FIG. 11, light waveguides 11R, 11G, and 11B are formed in layers hierarchically along the third direction Z in the distributing light guide element 10A.

The distributing light guide element 10A includes a main surface MS1A opposing the light guide 20A, a main surface MS2A located on an opposite side to the main surface MS1A along the third direction Z, a side surface SS5A opposing the light source LS1, and a side surface SS6A located on an opposite side to the side surface SS5A along the second direction Y and opposing the reflector REF1.

The light guide 20A includes a main surface MS3A opposing the display panel PNL1, a main surface MS4A located on an opposite side to the main surface MS3A along the third direction Z and opposing the main surface MS1A of the distributing light guide element 10A, a side surface SS7A overlapping the side surface SS5A of the distributing light guide element 10A, and a side surface SS8A opposing the reflector REF1 and overlapping the side surface SS6A of the distributing light guide element 10A.

The light waveguides 11R, 11G, and 11B formed in the distributing light guide element 10A are bent in the third direction Z (upward) near the end portions 11b. In more detail, the light waveguides 11 are bent upward at an angle θd (for example, 26.5°) with respect to the second direction Y in the Y-Z plane.

The light emitted from the end portions 11b of the light waveguides 11R, 11G, and 11B is reflected by the reflector REF1. The light reflected by the reflector REF1 proceeds toward the main surface MS3A of the light guide 20A and is reflected at the interface between the main surface MS3A of the light guide 20A and the air layer. The light totally reflected at the main surface MS3A proceeds toward the main surface MS4A and its proceeding direction is changed by the prism layer P1 provided on the main surface MS4A. The light whose proceeding direction is changed by the prism layer P1 deviates from the total reflection condition of the main surface MS3A and is emitted from the main surface MS3A. The light emitted from the main surface MS3A is converted into light substantially parallel to the third direction Z by the prism sheet PS and then diffused by the diffusion sheet DS to illuminate the display panel PNL1.

Note here that the above-provided descriptions are set out while taking the illumination device ILD1 as an example, and the illumination device ILD2 as well has a similar configuration.

The illumination device ILD according to the third embodiment described above can be mounted in the display device DSP supporting a nose cut, and can exhibit advantageous effects similar to those of the first embodiment provided above. Further, the illumination device ILD according to the third embodiment can be mounted not only in the display device DSP as a head-mounted display, but also in, for example, the display device DSP in which a display panel PNL is arranged only in front of one eye, the display device DSP as a smart phone, the display device DSP as a monitor and the like. Further, in the illumination device of the third embodiment, a pair of the distributing light guide element 10 and the light guide 20 are arranged side by side along the third direction Z, and therefore it can contribute to the narrowing the frame of the display device DSP.

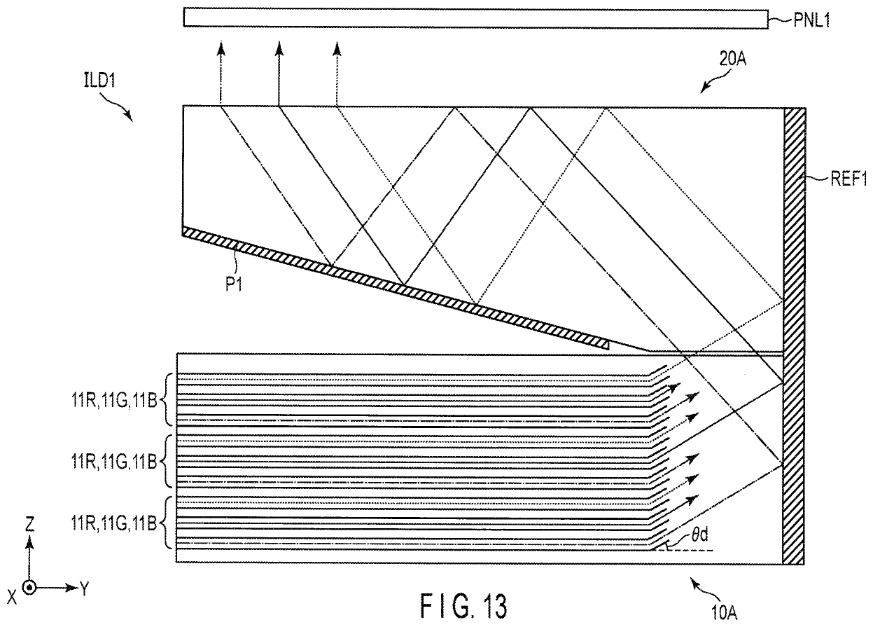

Note here that, as shown in FIG. 11, it is assumed that the cross-sectional shape of the light guide 20A is a so-called inverse wedge shape, but the shape is not limited to this. Note that the cross-sectional shape of the light guide 20A may as well be rectangular, as shown in FIG. 12. Further, FIG. 11 illustrates only one of each of the light waveguides 11R, 11G, and 11B, but as shown in FIG. 13, a plurality of each of the light waveguides 11R, 11G, and 11B may as well be formed in layers hierarchically.

### Modified Example of Third Embodiment

A modified example of the third embodiment will now be described. The illumination device ILD according to the modified example of the third embodiment is different from that of the third embodiment in that the distributing light guide element 10 and the light guide 20 are integrated as one body. In the following, explanations of parts similar to those of the third embodiment will be omitted.

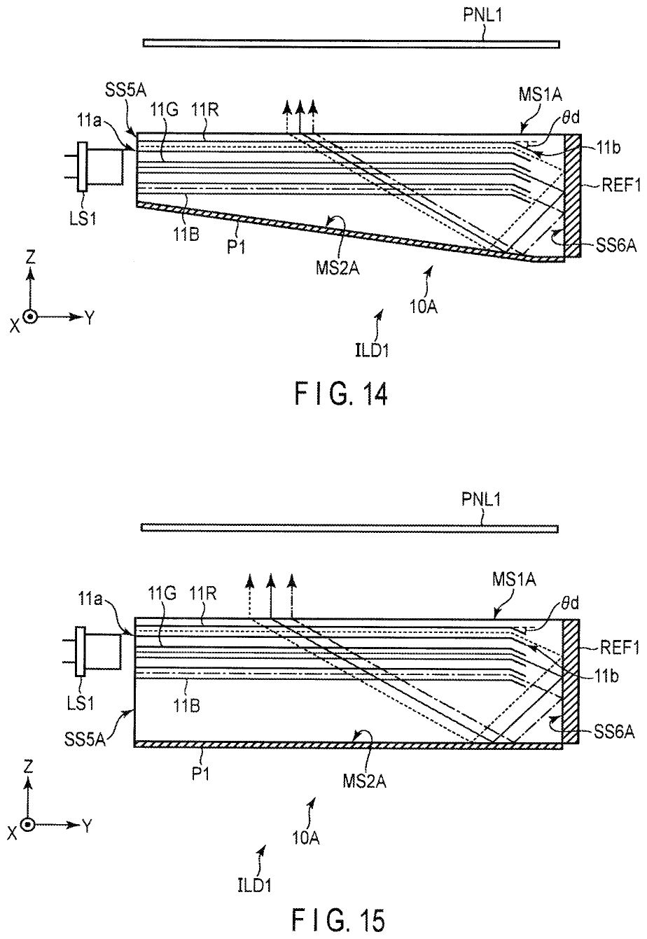

FIG. 14 is a cross-sectional view schematically showing the illumination device ILD1 according to the modified example of the third embodiment. As shown in FIG. 14, light waveguides 11R, 11G, and 11B are formed in layers hierarchically along the third direction Z in the distributing light guide element 10A.

As shown in FIG. 14, the illumination device ILD1 includes a light source LS1, a distributing light guide element 10A, and a reflector REF1. The distributing light guide element 10A includes a main surface MS1A opposing the display panel PNL1, a main surface MS2A located on an opposite side to the main surface MS1A along the third direction Z and on which the prism layer P1 is provided, a side surface SS5A opposing the light source LS1, and a side surface SS6A located on an opposite side to the side surface SS5A along the second direction Y and opposing the reflector REF1.

As shown in FIG. 14, the light waveguides 11R, 11G, and 11B formed in the distributing light guide element 10A are bent in the third direction Z (downward) near the end portions 11b. In more detail, the light waveguides 11R, 11G, and 11B are bent downward at an angle θd (for example, 26.5°) with respect to the second direction Y in the Y-Z plane. Light emitted from the end portions 11b of the light waveguides 11R, 11G, and 11B passes through the side surface SS6A and is reflected by the reflector REF1. The light reflected by the reflector REF1 proceeds toward the main surface MS2A of the distributing light guide element 10A, and its proceeding direction is changed by the prism layer P1 provided on the main surface MS2A. The light whose proceeding direction is changed by the prism layer P1 deviates from the total reflection condition of the main surface MS1A and is emitted from the main surface MS1A. The light emitted from the main surface MS1A is converted into light substantially parallel to the third direction Z by the prism sheet PS and then diffused by the diffusion sheet DS to illuminate the display panel PNL1.

Note here that the above-provided descriptions are set out while taking the illumination device ILD1 as an example, and the illumination device ILD2 as well has a similar configuration.

The illumination device ILD according to the modified example of the third embodiment described above can exhibits advantageous effects similar to those of the third embodiment provided above. Further, the illumination device ILD according to the modified example of the third embodiment can achieve a structure having a smaller thickness (length in the third direction Z) as compared to that of the illumination device ILD according to the third embodiment. The cross-sectional shape of the distributing light guide element 10A is not limited to the inverted wedge shape shown in FIG. 14, but may as well be rectangular, for example, as shown in FIG. 15.

### Fourth Embodiment

Next, the fourth embodiment will be described. The illumination device ILD of the fourth embodiment has a configuration in which the structure of the illumination device ILD of the second embodiment and the structure of the illumination device ILD of the modified example of the third embodiment are combined together. More specifically, the illumination device ILD according to the fourth embodiment has a configuration whose shape in plan view is rectangular and does not have a notch (nose cut) and a configuration in which the distributing light guide element 10 and the light guide 20 are integrated as one body.

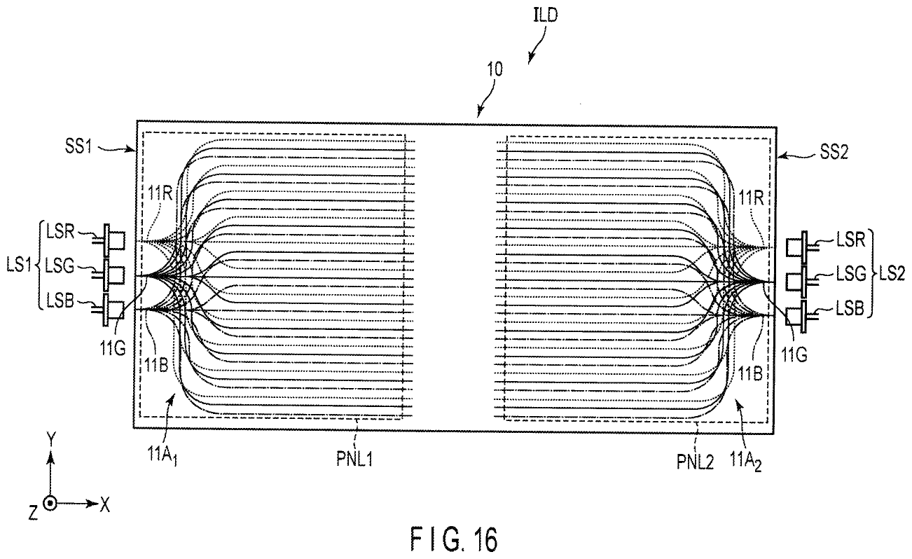

FIG. 16 is a plan view schematically showing the illumination device ILD according to the fourth embodiment.

As shown in FIG. 16, the illumination device ILD comprises light sources LS1, LS2 and a distributing light guide element 10.

As shown in FIG. 16, the shape of the distributing light guide element 10 in plan view is rectangular and includes a side surface SS1 opposing the light source LS1 and a side surface SS2 opposing the light source LS2. The distributing light guide element 10 includes a plurality of light waveguides 11A1 extending from the side surface SS1 towards the side surface SS2 to near the center of the distributing light guide element 10 and a plurality of light waveguides 11A2 extending from the side surface SS2 towards the side surface SS1 to near the center of the distributing light guide element 10. The plurality of light waveguides 11A1 and 11A2 each include light waveguides 11R, 11G, and 11B. The plurality of light waveguides 11A1 and 11A2 are spaced apart from each other near the center of the distributing light guide element 10.

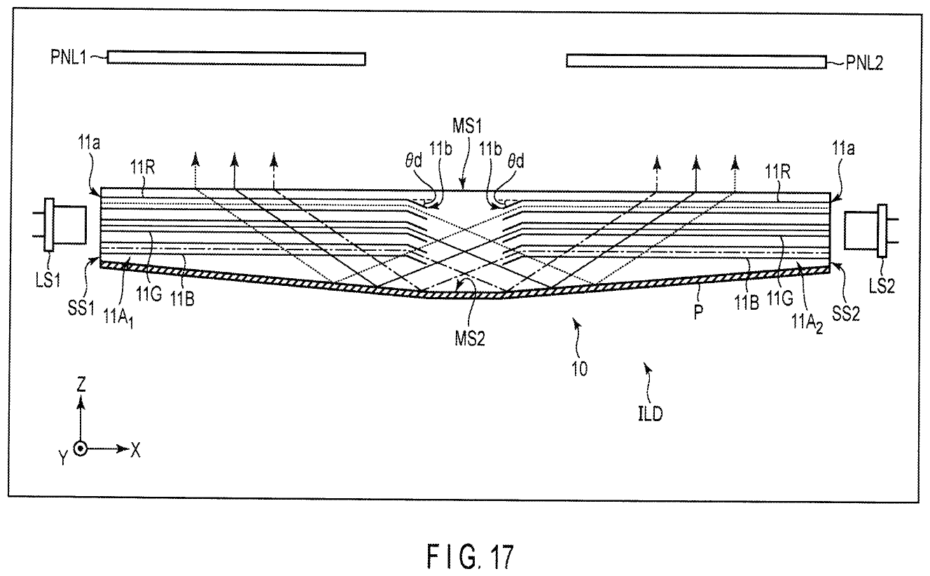

FIG. 17 is a cross-sectional view schematically showing the illumination device ILD according to the fourth embodiment. As shown in FIG. 17, light waveguides 11R, 11G, and 11B contained in the light waveguide 11A1 and light waveguides 11R, 11G, and 11B contained in the light waveguide 11A2 are formed in layers hierarchically along the third direction Z, respectively, in the distributing light guide element 10.

As shown in FIG. 17, the distributing light guide element 10 includes a side surface SS1 opposing the light source LS1, a side surface SS2 opposing the light source LS2, a main surface MS1 opposing the display panels PNL1 and PNL2, and a main surface MS2 located on an opposite side to the main surface MS1 along the third direction Z. On the main surface MS2, a prism layer P including a plurality of prisms is provided.

The light waveguides 11R, 11G, and 11B contained in the light waveguide 11A1 and the light waveguides 11R, 11G, and 11B contained in the light waveguide 11A2 formed in the distributing light guide element 10 are bent in the third direction Z (downward) near the end portions 11b. In more detail, the light waveguides 11R, 11G, and 11B contained in the light waveguide 11A1 and the light waveguides 11R, 11G, and 11B contained in the light waveguide 11A2 are bent downward at an angle θd (for example, 26.5°) with the first direction X in the X-Z plane.

Light emitted from the end portions 11b of the light waveguides 11R, 11G, and 11B contained in the light waveguide 11A1 proceeds toward the main surface MS2 and its proceeding direction is changed by the prism layer P on the display panel PNL2 side (right side in the figure) among the prism layers P provided on the main surface MS2. The light whose proceeding direction is changed by the prism layer P deviates from the total reflection condition of the main surface MS1 and is emitted from the area of the main surface MS1, which opposes the display panel PNL2.

The light emitted from the end portions 11b of the light waveguides 11R, 11G, and 11B contained in the light waveguides 11A2 proceeds toward the main surface MS2 and its proceeding direction is changed by the prism layer P on the display panel PNL1 side (left side in the figure) among the prism layers P provided on the main surface MS2. The light whose proceeding direction is changed by the prism layer P deviates from the total reflection condition of the main surface MS1 and is emitted from the area of the main surface MS1, which opposes the display panel PNL1.

Light emitted from the main surface MS1 is converted into light substantially parallel to the third direction Z by the prism sheet PS and then diffused by the diffusion sheet DS to illuminate the display panels PNL1 and PNL2.

The illumination device ILD according to the fourth embodiment described above can exhibit advantageous effects similar to those of the first embodiment provided above, except that it does not support nose cutting. Further, the illumination device ILD according to the fourth embodiment does not require stacking a structure for illuminating the display panel PNL1 and a structure for illuminating the display panel PNL2 in the third direction Z as in the cases of the illumination devices ILD according to the first to third embodiments, and therefore it is possible to realize a structure with a thickness (length in the third direction Z) less than those of the illumination devices ILD according to these embodiments.

According to at least one of the embodiments described above, it is possible to provide an illumination device ILD which can realize a display device DSP as a head mounted display at lower cost.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An Illumination device comprising:
light sources;
a distributing light guide element including a first side surface opposing the light sources, a second side surface on an opposite side to the first side, and light waveguides extending from the first side surface towards the second side surface; and
a light guide including a third side surface opposing the second side surface and a first main surface, wherein
each of the light waveguides includes a first end portion into which light emitted from a corresponding light source enters, and a second end portion from which the light entering from the first end portion and propagating in the light waveguide is emitted, and
the light emitted from the second end portion enters the light guide via the second side surface and the third side surface, propagates in the light guide, and is emitted from the first main surface.

2. The illumination device of claim 1, wherein
the second side surface and the third side surface are parallel to each other, and
the light waveguides are each bent in a thickness direction near the second end portion.

3. The illumination device of claim 1, wherein
the third side surface is inclined with respect to the first main surface, and
the second side surface and the third side surface are not parallel to each other.

4. The illumination device of claim 2, wherein
the light sources include a first light source which emits red laser light, a second light source which emits green laser light, and a third light source which emits blue laser light.

5. The illumination device of claim 4, wherein
a light waveguide corresponding to the first light source, a light waveguide corresponding to the second light source, and a light waveguide corresponding to the third light source are located hierarchically along the thickness direction and do not intersect each other.

6. The illumination device of claim 1, wherein
the light guide further includes a second main surface on an opposite side to the first main surface and a prism layer provided on the second main surface.

7. An illumination device comprising:
light sources;
a distributing light guide element including a first side surface opposing the light sources, a second side surface on an opposite side to the first side surface, and light waveguides extending from the first side surface towards the second side surface;
a light guide located above the distributing light guide element and including a first main surface and a third side surface overlapping the second side surface in plan view; and
a reflector opposing the second side surface and the third side surface, wherein
each of the light waveguides includes a first end portion into which light emitted from a corresponding light source enters, and a second end portion from which the light entering from the first end and propagating in the light waveguide is emitted, and
the light emitted from the second end portion is reflected by the reflector, enters the light guide, propagates in the light guide, and is emitted from the first main surface.

8. The illumination device of claim 7, wherein
the light waveguides are each bent in a thickness direction near the second end portion.

9. The illumination device of claim 7, wherein
the light sources include a first light source which emits red laser light, a second light source which emits green laser light, and a third light source which emits blue laser light.

10. The illumination device of claim 9, wherein
a light waveguide corresponding to the first light source, a light waveguide corresponding to the second light source, and a light waveguide corresponding to the third light source are located hierarchically in the thickness direction and do not intersect each other.

11. The illumination device of claim 7, wherein
the light guide further includes a second main surface opposing the first main surface and a prism layer provided on the second main surface.

12. An illumination device comprising:
light sources;
a distributing light guide element including a first side surface opposing the light sources, a second side surface on an opposite side to the first side surface, a first main surface, and light waveguides extending from the first side surface towards the second side surface, and
a reflector opposing the second side surface, wherein
each of the light waveguides includes a first end portion into which light emitted from a corresponding light source enters, and a second end portion from which the light entering from the first end portion and propagating in the light waveguide is emitted, and
the light emitted from the second end portion is reflected by the reflector, propagates in the distributing light guide element, and is emitted from the first main surface.
